(19) United States
(12) Patent Application Publication
(10) Pub. No.: US 2009/0026182 A1
(43) Pub. Date: Jan. 29, 2009

(54) IN-SITU BRAZING METHODS FOR REPAIRING GAS TURBINE ENGINE COMPONENTS

(75) Inventors: YIPING HU, GREER, SC (US); CLYDE R. TAYLOR, LAURENS, SC (US); ALBERT F. GONZALEZ, GREENVILLE, SC (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/829,358

(22) Filed: Jul. 27, 2007

(51) Int. Cl. B23K 26/20; B23K 26/42

(52) U.S. Cl. 219/121.64; 219/72

(57) ABSTRACT

Methods are provided for repairing cracks in a damaged section of a gas turbine engine component with an in-situ brazing process. In an embodiment, by way of example only, the method includes applying a braze paste to the damaged section of the component, the braze paste comprising a braze material and an organic binder. The method also includes subjecting the damaged section of the component to a first temperature that is below a brazing temperature of the braze material to thereby substantially decompose and evaporate the organic binder, and heating the braze material using laser energy to a second temperature that is substantially equal to or above the brazing temperature to form the brazed joint on the component.

### TECHNICAL FIELD

The inventive subject matter generally relates to metallic components of gas turbine engines, and more particularly relates to methods for repairing turbine engine components.

### BACKGROUND

Turbine engines are used as a primary power source for various kinds of aircraft. Most turbine engines generally follow the same basic power generation procedure. Air is ingested into a fan section, and passes over stator vanes that direct the air into a compressor section to be compressed. The compressed air is flowed into a combustor, is mixed with fuel and burned, and the expanding hot gases are directed, at a relatively high velocity, against stationary turbine vanes in the engine. The vanes turn the high velocity gas flow partially sideways to impinge on blades mounted on a rotatable turbine disk. The force of the impinging gas causes the turbine disk to spin at high speeds. Jet propulsion engines use the power created by the rotating turbine disk to draw more air into the engine and the high velocity gas is passed out of the turbine to create forward thrust.

After repeated operation, some components may experience thermal fatigue, oxidation and/or corrosion degradation. As a result, the component may become damaged and may develop small cracks and/or materials loss therein. To repair these components, conventional welding techniques, such as plasma transferred arc (PTA) welding or tungsten inert gas (TIG) welding, have been used in the past. Typically for these techniques, the component is placed in an inert gas atmosphere, and a filler material is then welded to a damaged section of the component.

Although conventional welding techniques are useful for repairing some components of the turbine engine, they have some drawbacks when repairing others. For example, some components, such as housings used in the combustor, air diffusers used in the compressor, and bearing support housings, may be made of different kinds of sheet metals. Thus, during welding operation when the component is heated to high temperatures, it may be experience different strain and stress levels in different areas due to varying rates of deformation in those areas. Consequently, the component may develop additional cracks, which may result in repeated repairs, or discard and replacement of the component. In another example, components made of two or more kinds of materials having different thermal expansion coefficients may also develop additional cracks, if subjected to PTA or TIG welding techniques. Specifically, these techniques may cause hot cracking and/or part distortion due to relatively excessive heat input.

Accordingly, an improved method for repairing cracks is desired. In particular, it is desirable to have a method that does not cause the formation of additional cracks in a component to be repaired. In addition, it is desirable for the method to be relatively simple and inexpensive to implement. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Methods are provided for repairing a damaged section of a component. In an embodiment, by way of example only, the method includes applying a braze paste to the damaged section of the component, the braze paste comprising a braze material and an organic binder. The method also includes subjecting the damaged section of the component to a first temperature that is below a brazing temperature of the braze material to thereby substantially decompose and evaporate the organic binder, and heating the braze material to a second temperature that is substantially equal to or above the brazing temperature using laser energy.

In another embodiment, a method is provided for repairing a crack or material loss in a damaged section of a component comprising a superalloy with a brazed joint or buildup. Surface contaminants are removed from an area around the crack formed in the damaged section of the superalloy component. A braze paste is applied to the damaged section of the superalloy component. The braze paste includes a braze material and an organic binder. The damaged section of the superalloy component is heated in a vacuum furnace to a temperature in a range of between about 500° C. to 550° C. for a period of time in a range of between about 0.5 to 1.0 hour to thereby substantially decompose and evaporate the organic binder. The braze material is heated using laser energy to a second temperature that is substantially above the brazing temperature to form the brazed joint.

### BRIEF DESCRIPTION OF THE DRAWINGS

The inventive subject matter will hereinafter be described in conjunction with the following drawing figures, wherein like numerals denote like elements, and

FIG. 1 is a partial cross-sectional side view of a turbofan jet engine, according to an embodiment;

FIG. 2 is a cross-sectional view of a damaged section of a component including a crack, according to an embodiment; and

FIG. 3 is a flow diagram of a method for repairing components of a turbofan jet engine, according to an embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

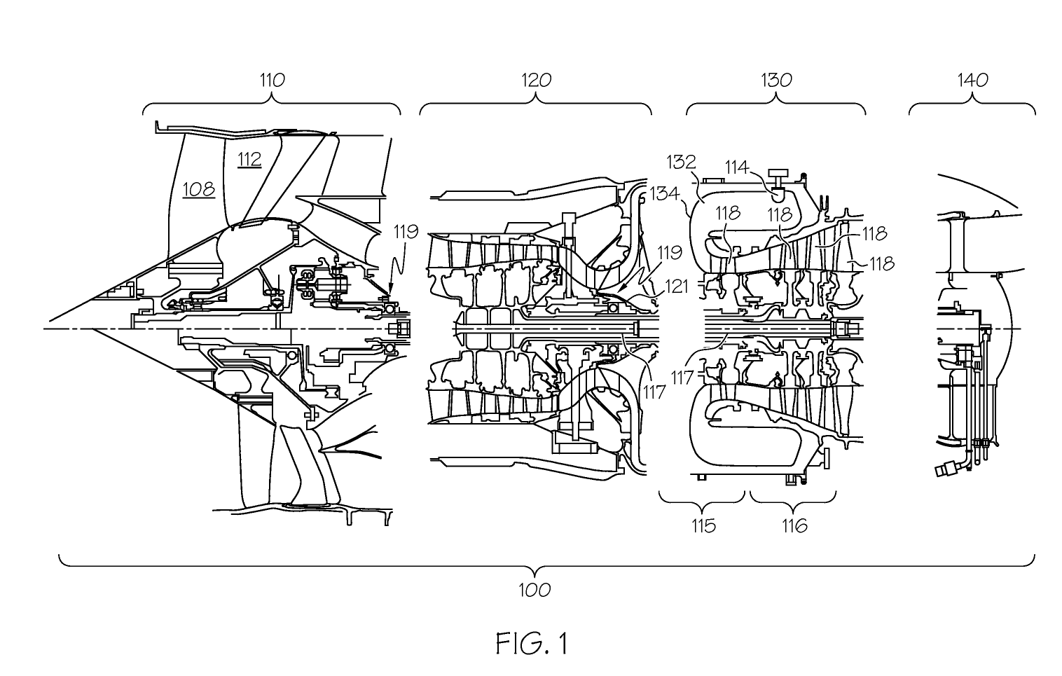

Turning now to the description and with reference first to FIG. 1, a partial cross-sectional side view of a turbofan jet engine 100 is depicted. The turbofan jet engine 100 includes a fan module 110, a compressor module 120, a combustor and turbine module 130, and an exhaust module 140. The fan module 110 is positioned at the front, or “inlet” section of the engine 100, and includes a fan 108 that induces air from the surrounding environment into the engine 100. The fan module 110 accelerates a fraction of this air toward the compressor module 120, and the remaining fraction is accelerated into and through a bypass 112, and out the exhaust module 140. The compressor module 120 raises the pressure of the air it receives to a relatively high level.

The high-pressure compressed air then enters the combustor and turbine module 130, where a ring of fuel nozzles 114 (only one illustrated) injects a steady stream of fuel into a combustor 132 that is made up of at least a combustor liner 134. The injected fuel is ignited by a burner (not shown), which significantly increases the energy of the high-pressure compressed air in the combustor 132. This high-energy compressed air then flows first into a high pressure turbine 115 and then a low pressure turbine 116, causing rotationally mounted turbine blades 118 on each turbine 115, 116 to turn and generate energy.

The energy generated in the turbines 115, 116 is used to power other portions of the engine 100, such as the fan module 110 and the compressor module 120. In particular, the turbines 115, 116 rotate a rotor 117 that extends through the engine 100, and the fan module 110 and the compressor module 120 are mounted to the rotor 117. To contain the rotation of the rotor 117, one or more bearing assemblies 119 are mounted around the rotor 117. The bearing assembly 119 is attached to the remainder of the aircraft structure via a bearing support housing 121.

The air exiting the combustor and turbine module 130 then leaves the engine 100 via the exhaust module 140. The energy remaining in the exhaust air aids the thrust generated by the air flowing through the bypass 112.

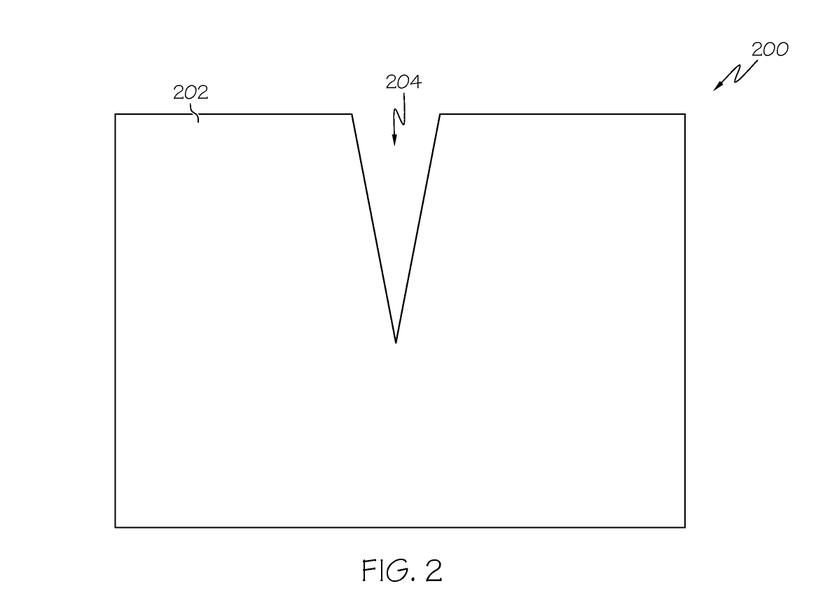

After repeated use, one or more of the components of the engine 100 may become damaged. In one example, the components may be made of a sheet metal or alloy and may develop one or more cracks due to either repeated thermal or mechanical stresses. These components may include those that make up the combustor and turbine module 130, such as the combustor liner 134, which may be susceptible to cracking from exposure to excessive heat. In another example, one or more components may be made of one or more alloys having different properties, such as different thermal expansion coefficients and mechanical properties. These components may also have complex geometry shapes. Examples include components that act as structural support for other engine components, such as bearing support housings 121, which may have a complex shape and may be made of different kinds of alloys. Turning to FIG. 2, a cross section view of a component 200 including a damaged section 202 is depicted, according to an embodiment. The damaged section 202 may include a relatively small crack 204 that may measure between about 1 and 3 cm in length and between about 0.1 and 0.2 cm in depth.

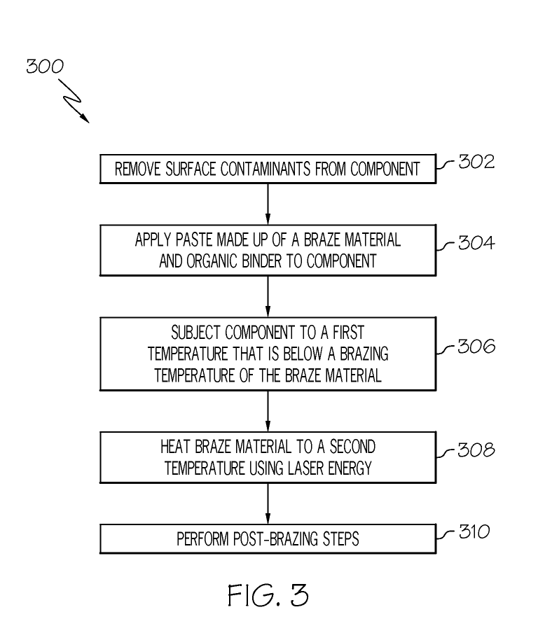

In any case, these components may be difficult to repair using conventional welding methods. In this regard, a method 300 depicted in a flow diagram in FIG. 3 may be used for repairing these types of components. The method 300 includes removing surface contaminants from an area around the crack 204 in a damaged section 202 of the component 200, step 302. Next, a braze paste is applied to the damaged section 202 of the component 200, the braze paste including a braze material, step 304. The damaged section 202 of the component 200 is subjected to a first temperature that is below a brazing temperature of the braze material to thereby decompose the organic binder, step 306. The braze material is then heated to a second temperature using laser energy, where the second temperature is substantially equal to or above a brazing temperature of the braze material to form the brazed joint, step 308. Each of these steps will now be discussed in more detail below.

As mentioned above, contaminants may be removed from an area around the crack 204, step 302. For example, contaminants, such as oxides, may be chemically or mechanically removed from the component. In an embodiment, the damaged section 202 and/or the crack 204 may be subjected to vapor phase fluoride ion cleaning. In such case, the component may be disposed in a container in which fluoride ions, such as those in the form of hydrogen fluoride vapor, are flowed over the component to remove oxides. The component may then be subjected to a vacuum cleaning which may substantially remove any remaining chemicals thereon. In another embodiment, SiC carbide stones or metal cutters may be used to physically remove contaminants from the damaged section 202 and/or crack 204. Subsequently, the damaged section 202 and/or crack 204 may be cleaned with an acetone rinse.

Next, a braze paste may be applied to the damaged section 202, step 304. In an embodiment, the braze paste may be disposed at least in the crack 204. In another embodiment, the braze paste additionally may be applied to the area around the crack 204. The braze paste may be made of a braze material and an organic binder. It will be appreciated that the formulation of the braze material may be tailored to a particular composition of the component. For example, if the component is formed from a nickel-based superalloy, the braze material may have a chemical composition that is substantially similar to the nickel-based superalloy of the component. In another embodiment, the component may be formed from a cobalt-based superalloy; thus, cobalt-based braze materials should be used to repair the defects. In any case, the braze material may have a lower melting point than the component alloys.

In an embodiment, the braze material includes a braze alloy powder. The braze alloy powder may be any one of numerous metal or alloy powders suitable for use in forming a brazed joint. For example, in an embodiment, the braze alloy powder may be a powder mixture that includes a high-melting temperature alloy powder and a low-melting temperature alloy powder. A “high-melting temperature alloy powder” may be defined as an alloy powder having a melting temperature of between about 1260° C. and about 1370° C. (e.g., about 2300° F. and about 2500° F.). A “low-melting temperature alloy powder” may be defined as an alloy powder having a melting temperature below 1150° C. (e.g., about 2100° F.), in an embodiment, or between 1065° C. and 1150° C. (e.g., 1950° F. and about 2100° F.) in another embodiment, or as low as about 980° C. (e.g., about 1800° F.), in still another embodiment.

Broadly, in an embodiment, the high-melting temperature alloy powder may refer to an alloy powder that has a similar composition to that of a nickel- or cobalt-based superalloy of a gas turbine engine component to be repaired. In an embodiment of a nickel-based high-melting temperature alloy powder, the powder may include, by weight, about 60% Ni, about 10% W, about 10% Co, about 8.3% Cr, about 5.5% Al, about 1% Ti, about 3% Ta, about 0.1% Zr, about 0.7% Mo, about 0.15% C, about 0.01% B and about 1.5% Hf. In an embodiment of a cobalt-based high-melting temperature alloy powder, the powder may include, by weight, about 10% Ni, about 7% W, about 55% Co, about 23.5% Cr, about 0.2% Ti, about 3.5% Ta, about 0.5% Zr, and about 0.6% C.

The low-melting temperature alloy powder may refer to an alloy powder that includes a melting point depressant, such as boron and/or silicon. In general, low-melting temperature alloy powder has lower melting temperature than material from which the component is made. The low-melting temperature alloy powder may include, by weight, about 68.0% Ni, about 4.0% Al, about 3.5% Ta, about 4% W, about 10.0% Co, about 9.0.0% Cr, 1.5% Hf and about 2.5% B. In still another embodiment, the low-melting temperature alloy powder may include, by weight, about 10% Ni, about 7% W, about 51.5% Co, about 23.4% Cr, about 0.2% Ti, about 0.5% Zr, about 0.6% C, about 2.7% B, and about 0.4% Si.

The high-melting and low-melting temperature alloy powders may be combined in a predetermined ratio to form the braze alloy powder. The predetermined ratio may depend on the particular material of the component to be repaired, the application for which the component to be repaired will be used, the thermal environment to which the component will be exposed, and other similar factors. For example, the braze alloy powder may include a greater percentage by weight of the high-melting temperature alloy powder (e.g., greater than about 60%) if the component is to be subjected to dimension and contour restoration in a later step. In an embodiment, the braze alloy powder includes between about 40-70% of the high-melting temperature alloy powder and between about 30-60% of the low-melting temperature alloy powder. As alluded to above, the braze alloy powder may be mixed with an organic binder. To form the paste, the braze alloy powder and organic binder may be mixed with a ratio of about 88 to about 12, by weight percentage.

The braze paste may be applied to the crack using any suitable technique. In an embodiment, a paintbrush may be used to paint the braze paste onto the component. In another embodiment, the braze paste may have a relatively thin consistency and may be poured onto the component. In still another embodiment, the braze paste may be applied onto component using syringe

After the braze paste is applied at least to the crack 204, the damaged section 202 is then subjected to a temperature suitable to substantially decompose and evaporate the organic binder in the paste, step 306. The phrase “substantially decompose” may be defined as altering a microstructure of the organic binder such that substantially all of the organic binders burn off. In an embodiment, the component is heat-treated using a predetermined temperature for a predetermined duration of time. For example, the component may be disposed in a conventional vacuum furnace and subjected to the predetermined temperature for the predetermined duration of time. In another embodiment, the heat treatment may be localized to the damaged section 202. For instance, a heating apparatus, such as a laser system or hand-held laser, may be used to heat the damaged section 202 of the component. The predetermined temperature may be a temperature that is below the brazing temperature (e.g. more than 600 degrees C. below) and at or above a temperature at which the organic binder in the braze paste will decompose or burn off. In particular, the predetermined temperature is below a temperature at which the microstructure of the component could not be altered. In an embodiment, the predetermined temperature may be less than half the brazing temperature. In one example, the braze material may have a brazing temperature of 1200° C. and the predetermined temperature may be between about 500° C. and 550° C., and preferably about 538° C. The predetermined duration of time material may be a duration that allows the organic binder to decompose and evaporate. In an embodiment, the predetermined duration of time may be about 1 hour. It will be appreciated that the lower the temperature, the more time may be employed, and vice versa.

The braze material is then heated using laser energy to a second temperature that is substantially equal to or above the brazing temperature to form the brazed joint on the component, step 308. The braze material may be directly heated or indirectly heated with laser energy. The laser energy may be provided by a hand-held laser. In an embodiment, the damaged section 202 and braze material are subjected to a laser-welding process in which the laser energy heats the braze material to a temperature substantially equal to or above that of the high-melting temperature powder alloy therein. In another embodiment, the damaged section 202 and braze material may be subjected to a laser-brazing process. In laser-brazing, the damaged section 202 is heated to the brazing temperature with a laser, and the heat is conducted through the component and to the braze material. Thus, the braze material melts without being directly heated by the laser. To prevent contaminants from being included in the resulting brazed joint, this step may occur in a protective atmosphere. For example, the protective atmosphere may be provided in a purge box that includes an inert gas, such as argon, disposed therein.

In an embodiment, one or more post-brazing steps may be performed, step 310. For example, the component may be machined to an original shape and/or original dimensions. In another example, at least one inspection process can be performed to determine whether any surface defects, such as cracks or other openings, exist. The inspection process can be conducted using any well-known non-destructive inspection techniques including, but not limited to, a fluorescent penetration inspection, and a radiographic inspection. If an inspection process indicates that a component is suitably in-situ braze-repaired, and then the repaired component is ready for use.

The following example is presented in order to provide a more complete understanding of the repair method 300. The specific techniques, conditions, materials and reported data set forth as illustrations, are exemplary, and should not be construed as limiting the scope of the inventive subject matter.

In an example, a base metal substrate including a crack thereon and made of Stellite® 31 superalloy supplied by Stellite Coatings of Goshen, Ind. was subjected to a pre-braze cleaning process. The cleaning processes included both hydrogen fluoride ion cleaning and mechanical removal of oxides. A braze paste was applied to the crack of the cleaned substrate. The braze paste was made up of a mixture of a braze alloy powder and an organic binder. The braze alloy powder included 50% by weight of a high-melting temperature alloy powder, and 50% by weight of a low-melting temperature alloy powder. The high-melting temperature alloy powder included, by weight, 54.5% Co, 10.0% Ni, 23.5% Cr, 7.0% W, 3.5% Ta, 0.2% Ti, 0.60% C, and 0.5% Zr. The low-melting temperature alloy powder included, by weight, 54.5% Co, 10.0% Ni, 23.5% Cr, 7.0% W, 3.5% Ta, 0.2% Ti, 0.60% C, 2.7%, 0.5% Zr, and 2.7% B. The organic binder was included in the braze alloy powder at 12%, by weight.

The cleaned substrate was then exposed to a pre-braze heat treatment at 538° C. for an hour. The heat treatment was used to substantially decompose the organic binder. Next, the braze paste was laser-brazed with a hand-held laser set at 750 Watts having a defocused laser beam of about 0.635 cm for between about 4-7 minutes to form a laser-brazed joint. The laser-brazed joint dimension was about 2.54 cm in length, about 0.230 cm in width, and about 0.152 cm in thickness. Optical photos showed the laser-brazed joint to be metallurgically sound. Microhardness measurements were taken of the laser-brazed joint and base alloy that fell between HV300 and HV350, indicating that both the substrate and the brazed joint had substantially similar microhardness properties. SEM microphotographs indicated that elements making up the braze paste and the substrate (except boron, which was not detected due to equipment limitations) were uniformly distributed in both the brazed joint and the substrate. Thus, by decomposing the organic binder without altering the microstructure of the component and before the step of brazing, a solid braze joint was formed.

Hence, an improved method for repairing cracks has been provided. The method may repair the component without the formation of additional cracks therein. In addition, the method may be relatively simple and inexpensive to implement, as compared to conventional repair methods. Moreover, by decomposing the organic binder before the step of brazing, an improved brazed joint is formed.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. An in-situ brazing method for repairing a crack in a damaged section of a component, the method comprising the steps of:
applying a braze paste to the damaged section of the component, the braze paste comprising a braze material and an organic binder;
subjecting the damaged section of the component to a first temperature that is below a brazing temperature of the braze material to thereby substantially decompose and evaporate the organic binder; and
heating the braze material with laser energy to a second temperature that is substantially equal to or above the brazing temperature to form a brazed joint on the component.

2. The method of claim 1, further comprising removing surface contaminants from an area around the crack formed in the damaged section of the component.

3. The method of claim 2, wherein the step of removing comprises:
chemically removing oxides from the component.

4. The method of claim 2, wherein the step of removing comprises:
mechanically removing oxides from the component.

5. The method of claim 4, wherein the step of removing further comprises:
applying acetone to clean the component.

6. The method of claim 1, wherein the step of subjecting the damaged section of the component to a first temperature comprises subjecting the component to a vacuum.

7. The method of claim 1, wherein the step of subjecting the damaged section of the component to a first temperature comprises exposing the component to a temperature in a range of about 500° C. to about 550° C. for a period of time in a range of between about 0.5 and about 1 hour.

8. The method of claim 1, wherein the step of subjecting the damaged section of the component to a first temperature comprises heating a portion of the component on which the braze material is applied to the first temperature with a laser.

9. The method of claim 1, wherein the step of heating the braze material comprises exposing the component to an inert gas atmosphere.

10. The method of claim 9, wherein the step of heating the braze material comprises exposing the component to an argon atmosphere.

11. The method of claim 1, further comprising machining the component to an original shape and an original dimension.

12. An in-situ brazing method for repairing a crack in a damaged section of a component comprising a superalloy to form a brazed joint, the method comprising the steps of:
removing surface contaminants from an area around the crack formed in the damaged section of the superalloy component;
applying a braze paste to the damaged section of the superalloy component, the braze paste including a braze material and an organic binder;
heating the damaged section of the superalloy component in vacuum furnace to a temperature in a range of between about 500 and about 550° C. for a period of time between about 0.5 and about 1 hour to thereby substantially decompose and evaporate the organic binder; and
heating the braze material with laser energy to a second temperature that is substantially equal to or above the brazing temperature to form the brazed joint on the superalloy component.

13. The method of claim 12, wherein the step of removing comprises:
chemically removing oxides from the superalloy component.

14. The method of claim 12, wherein the step of removing comprises:
mechanically removing oxides from the component.

15. The method of claim 14, wherein the step of removing further comprises:
applying acetone to clean the superalloy component.

16. The method of claim 12, wherein the step of subjecting the damaged section of the superalloy component to a first temperature comprises subjecting the superalloy component to a vacuum.

17. The method of claim 12, wherein the step of subjecting the damaged section of the superalloy component to a first temperature comprises heating a portion of the superalloy component on which the braze material is applied to the first temperature with a laser.

18. The method of claim 12, wherein the step of heating the braze material comprises exposing the superalloy component to an inert gas atmosphere.

19. The method of claim 18, wherein the step of heating the braze material comprises exposing the superalloy component to an argon atmosphere.

20. The method of claim 12, further comprising machining the component to an original shape and an original dimension.
